(19) United States
(12) Patent Application Publication
(10) Pub. No.: US 2014/0141978 A1
(43) Pub. Date: May 22, 2014

(54) WATER MISCIBLE MICROEMULSIONS OF WATER INSOLUBLE FILM FORMING POLYMERS

(71) Applicant: Kolazi S. Narayanan, Wayne, NJ (US)

(72) Inventor: Kolazi S. Narayanan, Wayne, NJ (US)

(73) Assignee: ISP Investmentts Inc., Wilmington, DE (US)

(21) Appl. No.: 14/232,095

(22) PCT Filed: Jul. 10, 2012
(86) PCT No.: PCT/US2012/046033

§ 371 Date: Jan. 10, 2014

Related U.S. Application Data
(60) Provisional application No. 61/506,317, filed on Jul. 11, 2011.

(51) Int. Cl. A01N 25/04

(52) U.S. Cl. CPC A01N 25/04
USPC 504/206; 514/772.5; 514/383

(57) ABSTRACT

A water miscible emulsion composition which is essentially free of long-chain alkylpyrrolidone and aromatic oil comprising: (i) a long chain substituted amide; (ii) a water insoluble film forming polymer; (iii) a water soluble anionic surfactant; and (iv) optionally, a bioactive, is particularly useful in providing water repellency and delaying the onset of fungi growth on crops and leaves.

### BACKGROUND OF THE INVENTION

The art has described various emulsion compositions for application on crops and leaves. See, for example, Narayanan U.S. Pat. No. 5,425,955—issued Jun. 20, 1995 “Compositions of Insoluble Film-Forming Polymers and Uses Thereof”; U.S. Pat. No. 5,766,615—issued Jun. 16, 1998 “Compositions of Insoluble Film-Forming Polymers and Uses Thereof”; and U.S. Pat. No. 5,283,229—issued Feb. 1, 1994 “Delivery System for Agricultural Chemicals”.

### TECHNICAL FIELD OF THE INVENTION

The present invention relates to a water miscible microemulsion composition which forms a clear solution upon dilution with water, and provides a protective coating on leaves/crops comprising: (i) a water insoluble film forming polymer; (ii) a long chain substituted amide; and (ii) a water soluble anionic surfactant. The film coating effect produced by the composition of the present invention typically results in water repellency and/or delaying of the onset of fungi growth on leaves/crops.

The emulsion composition can further comprise one or more bioactive or pesticides which can be sprayed on leaves/crops.

The bioactives contemplated for use herein include agricultural actives, fertilizers, preservatives, nutrients, plant growth accelerants, herbicides, plant growth regulators, insecticides, bactericides, fungicides, nematocides, fumigants, light stabilizers, UV absorbers, synthetic hydrocarbons, radical scavengers, resins, natural waxes, fragrances, paints, pigments, stains, organic solvents and monomers for polymers, disinfectants and/or combinations thereof.

In particularly preferred embodiments, the emulsion composition of the present invention is free of toxic and environmentally objectionable solvents/components. The present invention provides a composition that finds application in providing efficient delivery of water insoluble film forming polymers alone or in combination with agricultural actives. The present invention is suitable for film forming applications such as wood protection, plant protection, rain fastness effect, peripheral desiccation effect to prevent or delay onset of growth of fungi, providing higher crop yield and the like.

### DESCRIPTION OF THE PRIOR ART

Delivery of water insoluble film formers in water is a difficult task. One of the basic problems is their extreme insolubility in water. Certain types of polymers exhibit film-forming properties and when dissolved in an organic solvent, can be applied for the purpose of providing a water-resistant coating on a substrate. Usually, the film-forming polymer in the solvent is applied to the particular substrate to be coated, and the solvent is allowed to evaporate or removed leaving a film of the polymer. This results in the film former having to be dissolved either in organic solvents or utilized in the form of emulsions or suspensions. With respect to the use of organic solvents, these are generally disadvantageous from an environmental and cost viewpoint. Particularly, such organic chemicals may exhibit toxicity or side-effects which may be adverse to the effect of the actives/chemical itself or to its subsequent application. This toxicity may also be disadvantageous with respect to handling and may also adversely affect the environment.

Typical of such film forming polymers are copolymers of N-vinylpyrrolidone with α-olefins, styrene, esters such as vinyl acetate, acrylates, acrylic acids, amides, maleic acid, mono and diesters of maleic acids, vinyl ether co-polymers, natural waxes and the like.

Various attempts have been made to provide emulsified or suspension formulations. Difficulties have been encountered with respect to providing a desirably high concentration of the hydrophobic active ingredients, particularly agricultural, herbicides, pesticides etc. Emulsions (or macroemulsions) are usually unstable. The suspended droplets will eventually agglomerate and the dispersed phase will phase separate. Emulsion droplet sizes are much larger, typically one micron or more, resulting in a cloudy or milky dispersion. The nature of an emulsion may depend on the order of mixing of the ingredients and the amount of energy put into the mixing process. The final microemulsion state will not depend on order of mixing, and energy input only determines the time it will take to reach the equilibrium state. There have been limited efforts to develop micro-emulsions.

Thus, when such hydrophobically active chemicals are formulated into a macroemulsion (sometimes referred to herein as an emulsion), it is difficult to maintain the emulsified state. This, in turn, creates problems in maintaining a uniform formulation, particularly, when the formulation is diluted with water for application to plants, wood or as coatings.

The development of microemulsion technology has enabled formation of improved dispersions for some materials. Microemulsions are thermodynamically stable dispersions of one liquid phase into another, stabilized by an interfacial film of surfactant. This dispersion may be either oil-in-water or water-in-oil. Microemulsions are typically clear solutions, as the droplet diameter is approximately 100 nanometers or less. The interfacial tension between the two phases is extremely low.

U.S. Pat. No. 5,317,042 discloses a clear stable, efficacious aqueous microemulsion of a pyrethroid insecticide, alone, or in a complex mixture, obtained by mixing the insecticide with an inert matrix composition containing a defined mixture of nonionic surfactant to form a microemulsion concentrate, and diluting with water. The inert matrix composition consists of a predetermined mixture of nonionic surfactants which also included nonylphenol ethoxylate with HLB>6. However, the presence of nonylphenol ethoxylate in the formulation may be considered detrimental in some cases.

U.S. Pat. No. 5,425,955 discloses emulsion concentrates of water-insoluble film-forming polymers which can be utilized to form water-resistant films of active ingredients, such as, agriculturally active chemicals. Methods for preparation and use of the emulsion concentrates are disclosed.

Similarly, U.S. Pat. No. 5,766,615 discloses compositions that are composed of water-insoluble polymers, a surfactant, and a long chain alkylpyrrolidone and which form clear stable microemulsions or solutions of the insoluble polymer on the addition of water.

Another, U.S. Pat. No. 6,303,131 discloses a stable microemulsion of a particular class of water-insoluble film-forming polymers in water.

Most of the prior art suggests the use of alkyl pyrrolidone solvent as one of the major components of the matrix. However, in recent years more emphasis has been placed upon environmentally safe or EPA approved chemicals that can be safely applied to agricultural fields on growing crops. The compositions of the present invention can be comprised of all components approved by the EPA for application on growing crops or those exempt from approval.

U.S. Pat. No. 5,283,229 discloses the combination of alkyl pyrrolidones and dialkyl amides. The invention particularly relates to a concentrate which is composed of an agriculturally active chemical, a surfactant, and a solvent composed of first and second components. The first component is selected from the group consisting of N-methylpyrrolidone, ethylene carbonate, propylene carbonate, butylene carbonate, N—N, dimethylimidazolone, dimethyl formamide, dimethylacetamide, dimethylsulfoxide, and mixtures thereof and the second component is selected from the group consisting of octylpyrrolidone, dodecylpyrrolidone, N-2-ethylhexylpyrrolidone, and mixtures thereof.

U.S. Pat. No. 5,317,042 discloses a clear stable, efficacious aqueous microemulsion of a pyrethroid insecticide, alone, or in a complex mixture, obtained by mixing the insecticide with an inert matrix composition containing a defined mixture of nonionic surfactant to form a microemulsion concentrate, and diluting with water. The inert matrix composition consists of a predetermined mixture of nonionic surfactants which also included nonylphenol ethoxylate with HLB>6. However, the presence of nonylphenol ethoxylate in the formulation may be considered detrimental in some cases.

However, the microemulsion concentrates of the above related patents require a large amount of N-alkyl pyrrolidones including N-methylpyrrolidone for increased loading of the active ingredients. N-methylpyrrolidone is listed under California Proposition 65 with certain labeling restrictions. Furthermore, the use of the hydrophobic solvents disclosed in U.S. Pat. Nos. 6,541,516 and 6,187,715 limits the type of active ingredients and the loading depending on the solubility of the active ingredients in the hydrophobic solvent chosen.

Thus, it is desired to look for options which are environmentally safe and approved and are compatible with actives of interest. Thus, a need exists for alternative methods of dispensing of hydrophobic actives and/or water insoluble film forming polymers, particularly those which are used in agricultural fields.

Accordingly, it is an object of this invention to provide a water miscible microemulsion composition which upon dilution with water forms a clear solution, and which can be used within a relatively long time, without significant hydrolysis or precipitation.

Accordingly, an objective of the present invention is to provide substantially stable homogeneous, water soluble or water emulsifiable compositions which are suitable for providing delivery systems for film formers, particularly, water insoluble film forming polymers, alone or in combination with bioactives, preferably agricultural actives.

This invention provides a new class of water soluble microemulsions which provides a protective coating effect on leaves and crops, which not only causes water repellent surfaces but also delays the onset of fungi growth. The water miscible emulsion composition of the present invention can be used alone or mixed with bioactive, on dilution preferably with at least 10 fold water to form an emulsion/micro-emulsion which can be sprayed on to crops.

Thus, it is one of the objectives of the present invention to provide a water miscible emulsion composition, which upon dilution with water forms a clear solution, comprising:

(i) a water insoluble film forming polymer;
(ii) a long chain substituted amide;
(iii) an water soluble anionic surfactant; and
(iv) optionally a bioactive.

The water miscible emulsion of the present invention preferably is completely free of long-chain alkylpyrrolidone and aromatic oil.

The composition of the present invention can be used as a coating for substrates, such as wood, metal, glass and the like; as an adjuvant to enhance crop protection and yield and is compatible with several crop protection concentrates especially on dilution in water at use level. Further, the composition of the invention provides a water resistant film on application to surfaces, especially growing crops; rain-fastness during the crop growth and effective enhancement in the crop protection against pathogens or pests. Particularly when used in conjunction with fungicides insecticides and herbicides, the composition of the invention provides increased yield of the crop and is capable of being used as a granulating fluid to produce water-dispersible granules with the adjuvant incorporated.

### SUMMARY OF THE INVENTION

I have discovered a new water miscible microemulsion composition of a particular class of water-insoluble film forming polymers which can be utilized to produce protective films (coatings) on a given substrate such as wood, metal, glass and the like.

In accordance with the present invention, there is provided a water miscible emulsion composition which is essentially free of long-chain alkylpyrrolidone and aromatic oil comprising:

(i) a long chain substituted amide;
(ii) a water insoluble film forming polymer;
(iii) a water soluble anionic surfactant; and
(iv) optionally, a bioactive.

The water based composition can be further diluted with water with no separation of the film forming water-insoluble polymer (microdispersed with particle size of the range of around 20 nm) and results in a clear liquid.

The water-insoluble polymers used in the present invention preferably are selected from the group consisting of water-insoluble graft polymer of N-vinylpyrrolidone and an α olefin selected from the group consisting of C₁₆α-olefins in a 50:50 weight ratio and C₂₀α-olefins in a 20:80 weight ratio; polyacrylate; polystyrene acrylate copolymer; polystyrene butadiene copolymer; natural wax; polyisoprene copolymer and combinations thereof.

In one preferred embodiment, the water-insoluble polymer is graft polymer of vinylpyrrolidone and α-olefin wherein the polymerized N-vinylpyrrolidone fraction is present in more than about 5 percent on a weight basis. Preferably, the weight percent of polymerized N-vinylpyrrolidone fraction is at least about 10 percent. The α-olefin should contain from 8 to 30, and preferably, from 16 to 20 carbon atoms. The film-forming polymer preferably has a number average molecular weight up to about 50,000.

A suitable solvent, used for the present invention, to solubilize the polymer with wetting property is a long chain substituted amide, preferably an N,N-dialkyl acid amide or an N,N-dialkyl acid amide ester, having the formula:

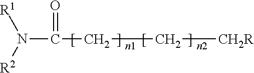

wherein, n₁=2-18; n₂=0-8 and n₁+n₂≧4,
R¹ and R² are lower alkyl with 1-4 carbon atoms, alicyclic or aromatic,

### R═H, OH, OR³, COOR^{S}, C(O)N(R³)₂, and

R³=lower alkyl chain with 1-4 carbon atoms.

In one preferred embodiment, R¹═R²═CH₃; R═H, n₂=0; n₁=5-11, and more preferably 7-9.

In another preferred embodiment, R¹═R²═CH₃; R═COOCH₃; n₂=0 and n₁=5-11.

In a preferred embodiment, the dialkyl acid amide or dialkyl acid amide ester is selected from the group consisting of N,N-dimethyl hexamide, N,N-dimethyl octanamide, N,N-dimethyl decanamide, N,N-dimethyl dodecanamide, N—N-dimethyl decamide, N,N-dimethyl tetradecanamide and N,N dimethyl amino alkyl acetate.

The water soluble anionic surfactant includes surfactants well known to those skilled in the art.

The water miscible emulsion composition additionally may comprise co-emulsifiers, co-solvents, wetting combinations, ionic emulsifiers, stabilizers and surface active buffers and mixtures thereof.

The amount of amide in the emulsion composition is from about 2-90 weight percent, preferably 8-50 weight percent. The amount of water insoluble film forming polymer is from about 1 to 50 weight percent. The amount of surfactant is from about 2 to 30 weight percent. All of these weights are based on the total weight of the emulsion composition.

Typically the aqueous inventive compositions are added to a bioactive material either individually or severally by using combinations of active ingredients or sprayed on growing crops in post emergent application or on the soil in pre-emergent application. The benefit derived by the use of the inventive composition is formation of a film incorporating the active ingredient on the leaf, soil or seeds which can prevent wash-out of the agriculturally active ingredient due to rain. Thus, for example, the composition with a bioactive forms a film on the particular substrate, e.g., the plant or soil, which results in improved retention and enhanced bioactivity of the agriculturally active and also provides superior rainfastness for such actives on leaf and substrate surfaces.

Typical use level of the inventive composition is 0.01 to 1.0% in the spray solution, preferably 0.1-0.3%. When added in the concentrate or to form water dispersible granules, the level of addition of the inventive composition is: 1-25%, preferably 2-15%, and most preferably 5-15%.

The emulsion results in clear solution when diluted with water at 1/100-1/10000, containing 0.0005 to 5 wt. % of said hydrophobic actives based on the total diluted matrix composition.

Another preferred embodiment of the present invention provides a water miscible emulsion comprising, by weight:

(a) 5-80% of a straight long chain substituted amide;
(b) 1-60% of a water insoluble graft polymer of N-vinylpyrrolidone in combination with a olefins; and
(c) 1-25% of a water soluble anionic surfactant.

In particularly preferred embodiments, the emulsion composition of the present invention is essentially free of alkyl pyrrolidones and aromatic oils.

The bioactive is selected from agricultural actives, fertilizers, preservatives, nutrients, plant growth accelerants, herbicides, plant growth regulators, insecticides, bactericides, fungicides, nematocides, fumigants, paints, pigments, stains, light stabilizers, UV absorbers, synthetic hydrocarbons, radical scavengers, resins, natural waxes, fragrances, disinfectants and/or combinations.

The composition of the present invention can be used as an adjuvant to enhance crop protection and yield and are compatible with several crop protection concentrates especially on dilution in water at use level. The composition provides a water resistant film on application to surfaces, especially growing crops; rain-fastness during the crop growth; superior wetting properties to agricultural formulations; effective enhancement in the crop protection against the pathogen or pests like fungicides and insecticides and herbicides. The composition provides increased yield of the crop and is capable of being used as a granulating fluid to produce water-dispersible granules with the adjuvant incorporated, in addition to its use as a spreader/sticker/rainfast adjuvant.

### DESCRIPTION OF PREFERRED EMBODIMENTS

The composition of the present invention is suitable for the delivery of film forming polymers, particularly water insoluble film polymers, with or without the combination of bioactives. The approach is environmentally safe and at the same time has broad area of applications in term of crop protection and increased crop yield.

It is desirable to avoid organic solvents due to their cost and adverse toxicological and environmental properties. Thus, the use of water as a solvent for the film-making procedure is preferred. With the inventive composition, it becomes possible to place such ordinarily water-insoluble film-forming polymers in an aqueous based vehicle which can be handled and utilized in the same manner as a true solution of the polymer to form a film therewith. Thus, the inventive composition in microemulsion form may be coated as it is, or after further dilution with water, if desired, onto a substrate. The water is then removed as by evaporation to leave the polymer film remaining.

Further advantageous is the use of straight long chain substituted amides, particularly dimethyl amides, which with their wetting properties and hydrophilicity/hydrophobicity, solublize the film forming polymers. Another important feature of the long chain substituted amides useful herein is their proven environmental safety by various regulatory authorities. All of the essential components for the present invention are approved by EPA for application on growing food crops.

The present invention relates to a water miscible microemulsion essentially free of long-chain alkylpyrrolidone and aromatic oil and which upon dilution with water forms a clear liquid comprising:

(i) a long chain substituted amide;
(ii) a water insoluble film forming polymer;
(iii) a water soluble anionic surfactant; and
(iv) optionally a bioactive.

The long carbon chain of substituted amide can be either straight or branched.

The composition of the present invention is uniquely formulated to provide an efficient stable emulsion/micro-emulsion/dispersion of film forming polymers which on dilution with or without water along with agricultural actives produces films of the particular film forming polymer on a given substrate. The long chain amide and a film forming water insoluble polymer are present in the water in a microdispersible form, which can further be diluted with water with no separation of the film forming water insoluble polymer. The submicron particle size of the micro-dispersion ranges from about 10-1000 nm.

As used herein, the term “microemulsion” means an oil-in-water or water-in-oil, transparent thermodynamically stable dispersion of two or more immiscible liquids or a solid in a liquid wherein the dispersed phase consists of small droplets with diameters in the range of about 10 to 100 millimicrons. Such micro-emulsions are clear and appear as a single phase to the naked eye.

As used herein, the term “clear” or “transparent” as applied to a liquid means that the liquid appears as a single phase without any particulate or colloidal material or a second phase being present when viewed by the naked eye.

As used herein, the term “bioactive” means compounds and mixtures thereof which can be used as, agricultural actives, fertilizers, preservative, nutrients, plant growth accelerants, herbicides, plant growth controlling chemicals, and chemicals which are effective in killing plants, insects, microorganisms, fungi, bacteria and the like which are commonly referred to as insecticides, bactericides, fungicides, nematocides, fumigants, synergists, i.e., compounds which when used in conjunction with other bioactive enhance their activity and the like, as well as any other chemicals having properties which are suitable for preferably agricultural use in terms of application to plants or domestic uses for controlling insects and pests. The compounds are described/exemplified in U.S. Pat. No. 5,283,229, the disclosure of which is hereby incorporated by reference in its entirety.

As used herein, the term “high degree of loading in the concentrate” means a bioactive ingredient content of at least about 5 percent by weight.

The bioactive concentration should be as high as possible so long as it does not precipitate out upon dilution of the concentrate with water for a reasonable period of time and achieves the desired effect. Precipitation (crystal formation) on standing not only depletes the solution of actives; it can also lead to fouling of application equipment, i.e., sprayers, etc. With the present invention, it is possible to obtain concentrates with actives concentrations in excess of about 5 weight percent which form a stable emulsion upon being diluted with water. Preferably, the amount of active is from 5 to 30% and most preferably, 10 to 20%.

The inventive compositions can be added to a ready-to-spray solution obtained on dilution of the bioactive concentrate or can be incorporated to the concentrate. The concentration of the bioactive concentrate can vary from 1-90%, preferably 5-60%, most preferably from 10-40%. The concentrate can be either a wettable powder, emulsifiable concentrate, microemulsion concentrate, suspension concentrate, water based emulsion, water dispersible granules, granulars, or gels or bioactive concentrate coated films like cellulosic or other substrates and formats.

The “long chain substituted amide” used for the present invention preferably can be an N,N-dialkyl acid amide or an N,N-dialkyl acid amide ester, having the formula:

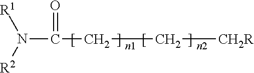

wherein, n₁=2-18; n₂=0-8 and n₁+n₂≧4,
R¹ and R² are lower alkyl with 1-4 carbon atoms, alicyclic or aromatic,

### R═H, OH, OR³, COOR^{S}, C(O)N(R³)₂, and

R³=lower alkyl chain with 1-4 carbon atoms.

The long carbon chain of substituted amide can be either straight or branched.

In one preferred embodiment, R¹═R²═CH₃; R═H, n=0; n₁=5-11, and more preferably 7-9.

In another preferred embodiment, R₁═R₂═CH₃; R═COOCH₃; n₂=0 and n₁=5-11.

Preferably, the amount of the amide present is from about at least about 2 to 90 weight percent, more preferably from about 8 to 50 weight percent, and most preferably from about 15 to 35 weight percent. Also, mixture of these amides may be used.

In a preferred embodiment, the dialkyl acid amide or dialkyl acid amide ester is selected from the group consisting of N,N-dimethyl hexamide, N,N-dimethyl octanamide, N,N-dimethyl decanamide, N,N-dimethyl dodecanamide, N—N-dimethyl decamide, N,N-dimethyl tetradecanamide and N,N dimethyl amino alkyl acetate.

These compounds are sold under the trademarks Halcomide by Stepan. See CP Hall Company, technical bulletin no. 827733 (July, 1974). See also U.S. Pat. No. 3,342,673, Rhodasolv PolarClean and other Rhodia products.

The “water-insoluble film polymer” used in the present invention can be selected from the group consisting of copolymers of vinyl pyrrolidone and α-olefins; polyacrylate; polystyrene acrylate copolymer; polystyrene butadiene copolymer; natural wax; polyisoprene copolymer and combinations thereof.

Polymers particularly suitable for use in the present invention include polymers, such as, Ganex 516, which is copolymer of an α-olefin and N-vinylpyrrolidone (50/50 percent mixture). Typically, such a olefins contain up to 20 carbon atoms and preferably, contain 16. The weight average molecular weight of such polymers is generally greater than about 20,000. Particularly suitable are water-insoluble polymers, such as, Agrimer AL25 (International Specialty Products (“ISP”)), which is a copolymer of an a olefin having the formula C₁₄H₂₉CH═CH₂ (50%) and N-vinylpyrrolidone (50%), and Agrimer AL30 (ISP), which is a copolymer of an α-olefin having 20 carbon atoms (80%), and N-vinylpyrrolidone (20%). All percents herein are percent by weight based on the total weight of the composition. See also U.S. Pat. No. 5,766,615.

Typically, the composition of the invention comprises from about 1 to 60 weight percent of the water insoluble polymer.

The term “water soluble anionic surfactant” used herein refers to surface active agents preferably selected from the group consisting of phosphate esters and their salts, alkyl sulfates, sulfonates, and their salts, salts of sulfate/sulfonate derived from nonylphenoxypoly(ethyleneoxy) ethanol, salts of alkylbenzene sulfonates, e.g., the sodium, calcium and alkylammonium salts, salts of alkylnaphthalene sulfonate, and sulfonated aliphatic polyesters and their salts.

The surfactant may be present in amounts from about 2 to 30%, preferably 5 to 22%, and most preferably, from 10 to 20%.

The emulsion of the present invention can further comprise solvent for the polymer, co-solvents, co-emulsifiers, wetting combinations, ionic emulsifiers, stabilizers and surface active buffers and mixtures thereof. These ingredients are known in the art.

Preferred co-solvents can be a synthetic or naturally occurring oil having a high hydrophobic character or having a fractional dispersive solubility parameter of greater than about 50%, preferably 70% and a molar volume of greater than about 150 cc/mole. These properties are defined in the C.R.C. Handbook referred to hereinabove.

Typical co-solvents include pyrrolidones, soybean oil, rapeseed oil, long chain alcohols, long chain ketones, long chain esters, ethers and hydrocarbons, aromatic petroleum oils.

In one embodiment, the co-solvent is a long-chain alkylpyrrolidone selected from the group consisting of octylpyrrolidone, dodecylpyrrolidone, N-2-ethylhexylpyrrolidone, and mixtures thereof.

In yet another embodiment, the co-solvent is an aromatic petroleum oil comprising about 60% of heavy aromatic solvent naphtha and about 40% of middle distillate solvent extractant. The co-solvent can be selected from alcohols, ethers, esters, ketones, aldehydes, aliphatic, aromatic, and cyclic hydrocarbons, naturally occurring flavoring agents, vegetable oils, flavoring agents, fragrances, monomers, propylene carbonate, propylene glycol, reduced vinyl pyrrolidone dimer, gamma-butyrolactone, N,N-dialkyl imidazolidone, cyclohexanone, methyl ethyl ketone, benzophenone, benzyl benzoate esters of long chain carboxylic acid with greater than 4 carbon atoms or esters with an alkyl group from the alcohol segment has more than 4 carbon atoms, alcohols having greater than six carbons, or hydrocarbon solvents for those active ingredients having high solubility and with low water solubility. Also suitable as the organic diluent are: natural oils, aromatic petroleum oils including those which are commercially available distillates from crude oils having an average boiling point greater than 200° C. Typical of such materials are those sold under the trademarks Exxon 200 or Texaco 400. Of course, such aromatics should be approved for use as a carrier for hydrophobic actives cited herein. The co-solvent may be present in amounts of from about 0 to 75% preferably 0 to 60%.

In one of the preferred embodiments, the water miscible emulsion of present invention is mixed with one or more bioactive, which when diluted with water 1/100-1/10000 results in clear liquids.

The bioactives can be selected from the group consisting of agricultural actives, fertilizers, preservatives, nutrients, plant growth accelerants, herbicides, plant growth regulators, insecticides, bactericides, fungicides, nematocides, fumigants, light stabilizers, UV absorbers, synthetic hydrocarbons, radical scavengers, resins, natural waxes, fragrances, organic solvents and monomers for polymers, disinfectants and/or combinations.

Yet another preferred embodiment of the present invention provides:

| Component | Level Wt/Wt |
|---|---|
| Dialkyl amide of long chain acid | 45.7% |
| Ganex 516 Solid | 15% |
| Sodium Lauryl sulfate (29% in water) | 39.3% |
| Total: | 100% |

In one of the preferred embodiments, N,N-dimethyl amide of octanoic acid and decanoic acid and Ganex V516 were mixed and charged to the reactor. Vacuum is pulled on the reactor and a nitrogen sparge is started. The reactor is then heated to 90° C. and held at this temperature until the distillate flow slows. The batch is then heated to 100° C. and held at this temperature until the distillate flow stops. DI water is then charged to the reactor and the reactor is reheated to 90° C. under full vacuum and nitrogen sparge. When distillate flow slows the reactor is heated to 100° C. until distillate flow stops. When the IPA has been removed the batch is cooled to 30° C. and aqueous sodium lauryl sulfate solution is charged to the reactor. The batch is mixed for 3 hours under a nitrogen blanket and then discharged. The reactor can be cleaned by water boil-out. The resulted product has water like appearance and has a Brookfield viscosity of 300 cps.

In a preferred embodiment, the water miscible emulsion is completely free of alkyl pyrrolidone.

In a preferred embodiment, the water miscible emulsion is completely free of any oil, particularly aromatic oils.

The inventive compositions are particularly suitable for end use applications wherein films of water-insoluble polymers are formed on substrates. The films may be formed for adhesive, protective, decorative, and lubricating purposes and to impart hydrophobicity or hydrophilicity. Since it is desirable to avoid organic solvents due to their cost and adverse toxicological and environmental properties, the use of water as a solvent for the film-making procedure is preferred. With the inventive composition, it becomes possible to place such ordinarily water-insoluble film-forming polymers in an aqueous based vehicle, i.e., solution, emulsion or dispersion-solubilizing liquid, which can be handled and utilized in the same manner as a true solution of the polymer to form a film therewith. Thus, the inventive composition in microemulsion form may be coated as is, or after further dilution with water, if desired, onto a substrate. The water is then removed as by evaporation to leave the polymer film remaining.

It has been further discovered that the rainfastness of bioactive, particularly agriculturally active, ingredients, and more particularly, pesticides, can be substantially improved by formulating the pesticides in the inventive composition including the water insoluble film-forming polymer. Many pesticides, and particularly water soluble agriculturally active chemicals, are washed off by rain after they have been applied to the plants or soil. For effective pest and weed control, it takes from a few hours to three weeks for the pesticide to penetrate (translocate) into the biological system. The present invention enables the agriculturally active ingredient to be retained under the polymer film for a sufficiently long time to allow it to be effective and avoid or reduce loss from rain wash-off.

In use, the inventive composition is diluted with water and applied to the crop, plants, or soil. Normally, this dilution is carried out at the field site. As used herein, rain resistant, rainfast or rainfastness in connection with the inventive compositions means that a film formed from the composition exhibits increased resistance to removal by water washing as compared to the same composition which does not contain the film-forming polymer under the test procedures as described hereinafter.

One of the main advantages the inventive composition provides is to replace totally the oil addition used in the spray solution during the crop development along with the fungicide. The various crops protected by the composition of present invention include banana, mango, pineapple, potato, cereals, tropical fruits, tea, coffee, etc. The type of oils referred herein include a petroleum distillate, paraffin oil, mineral oil, vegetable oils and other naturally derivitized oils.

One added advantage of the present invention over the prior art is to provide a “peripheral desiccating effect” on surface of leaves which makes the surface dry and water repellent and thus prevents the onset of fungal growth. This not only reduces the fungal attack but also increases the crop yield. Particularly, growing crops benefitted by the present invention are banana, potato, tea, coffee, fruit, and cereals.

In accordance with the present invention, emulsion concentrates may be prepared by mixing an active ingredient with the emulsion composition of the present invention comprising a film forming polymer and a solvent for the water-insoluble polymer (amide). Such solvents can also include co-solvents due to their high solubility for polymer and capability of emulsification with commonly used emulsifiers. These emulsion compositions may further be diluted with water to provide clear liquids.

The following examples further illustrate the invention:

### Example 1

### Preparation of the Inventive Composition

A stock solution is made by mixing 45 g of Hallcomid M 8-10 with 40 g commercially available 29% aqueous sodium dodecyl sulfate in a 4 oz. stoppered glass bottle and stirring in an orbital shaker for 30 min. 85 g of the above stock solution is mixed with 15 g dried Agrimer AL 25 in an automatic orbital shaker at 400 RPM for a period of 5 hours to produce a homogeneous aqueous composition shown in Table 1, Composition 1. On dilution with de-ionized water at 1/100 and 1/500, optically clear compositions are produced with no separation observed for one week. This composition is designed for use in aqueous systems which may be made up of water soluble active ingredients to provide rain-fastness and spreader/sticker improvements, and increased biological activity.

### Example 2

### Preparation of the Inventive Composition

The composition of Table 1 was made by using an IPA solution of Agrimer AL 25 at 50% in the place of the solid, using twice the quantity of the solid required [30 g], mixed with the organic solvent [45 g Hallcomid M 8-10], dissolved and by removing the IPA via flash distillation (15 g), followed by the addition of (40 g) 29% aqueous sodium dodecyl sulfate. The results are summarized in Table 2.

TABLE 1
Weight of water miscible emulsion compositions

| Ingredients | Composition 1 |
|---|---|
| Hallcomid M 8-10 | 45 |
| Agrimer AL 25 as solid | 15 |
| Sodium Lauryl sulfate as | 11.6 |
| solid | |
| water | 28.4 |
| Total | 100 |

Evaluation of the physical properties of compositions of Example 1 and 2 are described in Table 2:

TABLE 2
Physical properties of Composition 1

| Properties | Data | |
|---|---|---|
| Freezing point | <0 | deg C. |
| Flash point | [symbol] 105 | deg C. |
| Specific gravity | ~1.0 | |
| Viscosity | <200 | cps |
| Parricle size | <0.15 | microns |

| | |
|---|---|
| pH (1/10) | 7.05 |

Test Conditions with Commercial Formulations:

Prepare ready-to-spray dilutions using commercial formulations at rates specified. Prior to dilution, test compositions are added.

Transfer about 50 mL of each test sample in a tall Nessler tube or an equivalent test container and observe separation or sedimentation with time. See examples shown in Table 1.

### Example 3

### Particle Size of the Stable Dispersions/Emulsions

Composition 1 on dilution produced optically clear compositions with particle size<50 nm. Composition 1 on dilution at 1/10, 1/100, and 1/1000 are optically clear (Table 3).

TABLE 3
Dilution in water

Dilution

| | 1/1 | 1/10 | 1/100 | 1/1000 |
|---|---|---|---|---|
| Appearance | Slightly hazy | clear | clear | clear |

### Example 4

Following examples illustrate effective rainfastness when used with commercial formulations. Rainfast evaluation is carried out using commercial Prowl, 42% Pendimethalin formulated with commercial solvents and emulsifiers as described below.

A commercial formulation (commercial Prowl with 42 wt % Pendimethalin) is diluted to end-use concentration, at 1/100 with de-ionized water containing a theoretical amount of 0.42% Pendimethalin. This composition is used as a reference sample. This sample is designated as 3R (3 reference). An appropriate dose (0.1 g-0.5 g) is uniformly applied to a 6″×6″ glass plate as a 1-3″ square patch. The patch is dried in laboratory hood under ambient conditions for 48-72 hrs. Triplicate samples are used for reproducibility.

After a dry film is formed, a fine spray of water is applied to simulate 0.2-2″ rain wash off. Washings are collected in a waste jar. The remaining washed patch is extracted with a suitable solvent (ethanol) quantitatively in a 100 mL volumetric flask. Additional dilution in ethanol can be done if necessary to obtain UV absorbance within scale for linear regression.

The ethanol extract with appropriate dilution is examined under a calibrated UV spectrophotometer to obtain the absorbance at Lamda max. This value is designated a_{w}. An identical sample is generated using the same parameters, except no washing water is used. The absorbance is designated a_{b}. The % retention is calculated as: [a_{w}/a_{b}]×100. Lamda max for Pendimethalin is determined to be: 239 nm 0.3 g diluted sample is used to coat on 1-2 square inch patch on 6″×6″ glass plate, and typically 1.5 g-2.5 g water is used for wash. In all examples using any residual solvent in the formulation, samples of alcohol extract from the dried spot after washing are completely evaporated in a vacuum oven to remove any residual aromatic solvent to avoid interference therefrom in the absorbance analysis.

Following samples are prepared for rain-fast evaluation. 4 (1): (Pendamethylin blank/no treatment)—Reference sample as described above—1/100 diluted Prowl. 4 (2): One g Prowl is mixed with 0.65 g composition 1 and diluted to 100 g with de-ionized water.

The rainfastness 4 (2)>4 (1) of the compositions is expected to show increased retention of the active ingredient compared to the reference.

### Compatibility:

The inventive composition 4(2) (diluted at 1/100 containing ˜0.42% Pendimethalin) is stored in a tall Nessler tube and any separation is observed, compared to reference sample 4(1). After storage at time 0 hr, 8 hr, 24 hr, and 48 hr, 1 g sample is withdrawn from the middle of the tube and weighed accurately and transferred into a standardized volumetric flask and quantitatively diluted to 500 ml or an appropriate dilution and absorbance at 239 nm is measured at Lamda max. The theoretical amount would be 8.4 ppm. Relative stability of the concentrate and dilutions can be assessed by examining the relative recovery data.

### Example 5

Compatibility of inventive composition 1 and mixtures and a host of commercial formulations are evaluated by using the following procedure:

Commercial concentrates at ready-to-use dilutions are used along with the inventive compositions at different rates and the mixed compositions are tested for any visible separation over a period of time. These compositions are sprayed on baggable fruits and any visible toxicity to fruits on applications is examined.

### Commercial Concentrates Adjusted to Spray Per Hectare:

Baycor: 0.5 L in 30 L; Folicur: 0.23 L in 30 L; Siganex: 0.5 L in 30 L; Impulse: 0.64 L in 30 L; and Twist: 0.6 L in 30 L: all of the above are treated with 75 mL inventive compositions prior to dilution to 30 L to prepare the spray solutions and to use for compatibility evaluation.

The following additional commercial concentrates are also used.

Mazncozeb 80% WP: 1.5 pound is mixed in 20 pounds water and further diluted to 20 gallons to produce the sprayable solution per hectare

Bravo 40% SC: one gallon is diluted to 20 gallon to produce the sprayable solution per hectare The above two are treated with the inventive compositions at 180 ml prior to dilution to 20 gallons to prepare the spray solution and used for compatibility evaluation.

TABLE 4
Compositions used for testing compatibility of
inventive compositions with commercial products

| | | | | Additive |
|---|---|---|---|---|
| Commercial | Dilutions | | | in 30 L spray solution |
| Concentrates | Recommended | Spray rate | | used in one Ha |
| Currently used | use rate: 30 L | Spray solution | | Composition 1 |
| Baycor | 1/60 | 30 | L/Ha | 75 mL |
| Twist | 1/50 | 30 | L/Ha | 75 mL |
| Folicur | 1/130 | 30 | L/Ha | 75 mL |
| Impulse | 1/47 | 30 | L/Ha | 75 mL |
| Siganex | 1/60 | 30 | L/Ha | 75 mL |
| Mancozeb | 1.5/20 | 20 | gallon/Ha | 180 mL |
| 80% WP | | 75 | L/Ha | |
| Bravo 40% SC | 1/20 | 20 | gallon/Ha | 180 mL |
| | | 75 | L/Ha | |

### Results:

All compositions showed no separation or sedimentations observed from time 0 m, 10 m, 20 m, and 30 m. There is zero toxicity expected when sprayed on baggable fruits observed for 24 hours. The above is a standard test used in the field. All compositions are found to be compatible without significant separation or sedimentation.

### Example 6

### Compatibility of Existing Commercial Adjuvants and the Inventive Compositions

Banole used at 5 L in 30 L and the inventive composition 1 used at 75 mL in 30 L of spray solution.

Mixtures can be prepared at the ratio: 5 L Banol: 30 mL-300 mL of the inventive compositions and diluted to 30 L are found to be free from any separation or sedimentation when observed from time 0, 5, 10, and 15 m. Zero fruit toxicity is expected when the above compositions are treated with baggable fruits.

### Example 7

### Film Formation and Peripheral Desiccation Effects

In a green house experiment, the inventive compositions are sprayed at the rate of: 0.05%-0.25% on growing leaves in a plantation. After air drying the leaf is treated with water and the water is found to be repelled in certain areas of the treated leaf. When challenged with a fresh charge of the fungi a delay of 1 day-7 days for fungal infestation is noticed on the treated leaves. Excellent protection from fungal attack is expected when the plant is treated with a combination of commercial fungicides along with the inventive compositions as shown in Table 4.

### Example 8

### Bio-Efficacy

The compositions shown in Table 4 are tested for biological efficacy in controlling fungi on growing crops, and tested in banana plantation, at the spray rates specified using the first five active ingredients shown in column 1 of Table 4 and compared with plots sprayed without the inventive compositions. The efficacy of the inventive additive is compared with banole (natural oil) used at 5 L in 30 L spray solution per hectare. The inventive compositions used at 75 mL in 30 L, are expected to show much less fungi attack on the crop and the onset of fungal infestation is expected to be delayed. Best results are expected when inventive compositions are included in the spray solution ultimately providing better spray efficiency and improved quality and crop yield.

Mancozeb is tested with potato crop and control of blight. Bravo is tested with peanut crop and control of spot mildew. Treatment with the inventive compositions including Mancozeb as shown in Table 4 is expected to show better control of spot mildew compared with spraying with Mancozeb alone.

### Example 9

Following are some additional examples of field trial results, using the inventive compositions expected to show improved efficacy and yield of beneficial crop, winter wheat.

### Example 9A

Commercially available Cyproconazole is applied at 80 g/20 L and sprayed per acre in a growing winter wheat crop, with and without the inventive compositions applied at 0.15% in the 20 L spray solution. Mildew postules and brown rust is expected to be reduced more than 50% with increased crop yield.

### Example 9B

Commercially available Tebuconazole is spray applied at 100 g/20 L per acre in a growing winter wheat crop, with and without the inventive compositions applied at 0.15% in the 20 L spray solution. Mildew postules and brown rust are expected to be reduced by 30% with increased yield.

### Example 10

Following are examples of field trial results using the inventive compositions with potato crops.

Commercially available Flutriafol is applied at 22 mL in 14 L spray solution at 0.3 L/Hectare in a growing winter potatoes crop, with and without the inventive composition 1. Foliage blight is expected to be reduced by >50% and yield increased by 5%, when inventive composition is present.

### Example 11

Following are examples of field trial results using the inventive composition expected to show improved efficacy and yield of beneficial crop, soybeans.

Commercially available Tebuconazole is applied at 0.25% in the spray solution at 5.3 Fl Oz/acre in a growing soybean crop, with and without the inventive composition 1. Leaf spotting is expected to be reduced by 42%.

### Example 12

Following are examples used to evaluate water soluble active ingredients. Glyphosate (Round Up) is chosen as an example. In a commercial spray solution made up of 1.0 pound Glyphosate active ingredient from Round Up diluted in 20 gallons is applied per acre and effects of broad leaf and grass are evaluated with and without the addition of inventive water-based composition 1 at the rate of 0.25% in the spray solution. The activity on broad leaf control is expected to increase by two fold in the presence of the inventive composition with maximum effect at 3 weeks after application.

### Example 13

Example 12 is repeated except commercial Round Up is replaced by commercial Gramaxone (Paraquat). In a commercial spray solution made up of 0.625 pound Paraquat active ingredient is diluted in 20 gallon water and is applied per acre and effects of broad leaf and grass are evaluated with and without the addition of inventive water-based composition 1 at the rate of 0.25% in the spray solution. The activity on broad leaf control is expected to increase by two fold in the presence of the inventive composition with maximum effect within one week after application.

### Example 14

Water dispersible granules for water insoluble active ingredients with adjuvants incorporated

Water dispersible granules for water soluble active ingredients with adjuvants incorporated using Phosphonomethyl glycine sodium salt and composition 1 can be prepared. 500 parts of phosphonomethyl glycine is mixed with 400 parts of sodium bicarbonate, in a V-blender, the mixture is ground to a fine powder via an air mill to less than 2 micron size. The charge is transferred to a mixing bowl followed by addition of 150 g inventive composition 1 and 50 g water and a paste is made by kneading the composition to feed a laboratory extruder. The extruder is operated at maximum speed at a screen opening of 1 mm The extruded sample is dried in a laboratory fluid bed drier for 30 min at 40 C.

The extruded granules are expected to show excellent dissolution rate, no loss in friability, and acceptable hardness. The composition is a good candidate to test for anti-bounce of spray solutions applied on foliage.

1. A water miscible emulsion composition which is essentially free of long-chain alkylpyrrolidone and aromatic oil comprising:
(i) a long chain substituted amide;
(ii) a water insoluble film forming polymer;
(iii) a water soluble anionic surfactant; and
(iv) optionally, a bioactive.

2. A water miscible emulsion composition according to claim 1, wherein the long chain substituted amide is dialkyl acid amide or dialkyl acid amide ester having the formula: 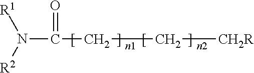
wherein, n₁=2-18; n₂=0-8 and n₁+n₂≧4,
R¹ and R² are lower alkyl with 1-4 carbon atoms,
R═H, OH, OR³, COOR³, C(O)N(R³)₂, and
R³=lower alkyl chain with 1-4 carbon atoms.

3. A water miscible emulsion composition according to claim 2, wherein R¹═R²═CH₃; R═H; n₂=0 and n₁=5-11.

4. A water miscible emulsion composition according to claim 3, wherein R¹═R²═CH₃; R═H; n₂=0 and n₁=7-9.

5. A water miscible emulsion composition according to claim 2, wherein R¹═R²═CH₃; R═COOCH₃; n₂=0 and n₁=5-11.

6. A water miscible emulsion composition according to claim 2, wherein the dialkyl acid amide or dialkyl acid amide ester is selected from the group consisting of N,N-dimethyl hexamide, N,N-dimethyl octanamide, N,N-dimethyl decanamide, N,N-dimethyl dodecanamide, N—N-dimethyl decamide, N,N-dimethyl tetradecanamide, and N,N dimethyl amino alkyl acetate and combinations thereof.

7. A water miscible emulsion composition according to claim 1, wherein the film-forming polymer is selected from the group consisting of water-insoluble graft polymer of N-vinylpyrrolidone and an α olefin selected from the group consisting of C₁₆α-olefins in a 50:50 weight ratio and C₂₀α-olefins in a 20:80 weight ratio; polyacrylate; polystyrene acrylate copolymer; polystyrene butadiene copolymer; natural wax; polyisoprene copolymer and combinations thereof.

8. A water miscible emulsion composition according to claim 7, wherein the film-forming polymer has a number average molecular weight up to about 50,000.

9. A water miscible emulsion composition according to claim 1, wherein the anionic surfactant is selected from the group consisting of lactylated fatty acid salts, anionic phospholipids, anionic non-fatty carboxylic acid esters of fatty acid/esters and their metal salts, fatty acids and their metal salts, alkali metal salts, alkaline earth metal salts and ammonium or amine salts or mixtures thereof, carboxylate salts, sulfates, sulfonates, phosphonates, phosphates, sarcocinates and mixtures thereof.

10. A water miscible emulsion composition according to claim 1, comprising from about 2 to 90% long chain substituted amide, from about 2 to 30% anionic surfactant, from about 1 to 50% water insoluble polymer and from about 1 to 50% water based on the total weight of the emulsion.

11. A water miscible emulsion composition according to claim 1, wherein the bioactive is selected from agricultural active, fertilizers, preservatives, nutrients, plant growth accelerants, herbicides, plant growth regulators, insecticides, bactericides, fungicides, nematocides, fumigants, paints, pigments, stains, light stabilizers, UV absorbers, synthetic hydrocarbons, radical scavengers, resins, natural waxes, fragrances, organic solvents, monomers for polymers, disinfectants and/or combinations thereof.

12. A water miscible emulsion composition according to claim 1, further comprising co-emulsifiers, co-solvents, wetting combinations, ionic emulsifiers, stabilizers and surface active buffers and mixtures thereof.

13. A water miscible emulsion composition according to claim 1, which on dilution with water forms a clear liquid.

14. A water miscible emulsion composition according to claim 1, wherein the water insoluble polymer forms a film having adhesive properties.

15. A water miscible emulsion composition according to claim 1, wherein the water insoluble polymer forms a film having protective properties.

16. A water miscible emulsion composition according to claim 1, wherein the water insoluble polymer forms a film having decorative properties.

17. A water miscible emulsion composition according to claim 1, wherein the water insoluble polymer forms a film having lubricating properties.

18. A water miscible emulsion composition according to claim 1, wherein the water insoluble polymer forms a film having hydrophobic properties.

19. A water miscible emulsion composition according to claim 1, wherein the water insoluble polymer forms a film having hydrophilic properties.

20. A method for forming a polymeric film on a substrate comprising applying the composition of claim 1 onto the substrate and removing the water.

21. A method for treating plants or soil with an agriculturally active comprising applying the composition of claim 1 to the plant or soil.

22. A method for forming the water miscible emulsion composition of claim 1 comprising the steps of
A) mixing a solid agriculturally active chemical in particulate form with NaHCO₃ in particulate form;
B) mixing the product from step A) with a composition comprising
(i) a long chain substituted amide
(ii) a water insoluble film forming polymer;
(iii) an anionic surfactant other than a long-chain alkylpyrrolidone; and
(iv) optionally diluted with water.
